(19) United States
(12) Patent Application Publication
(10) Pub. No.: US 2021/0054675 A1
(43) Pub. Date: Feb. 25, 2021

(54) ARTICLE INCLUDING COMPOSITE LAYER AND METHOD OF MAKING THE ARTICLE

(71) Applicant: 3M INNOVATIVE PROPERTIES COMPANY, St. Paul, MN (US)

(72) Inventors: Martin J.O. Widenbrant, Stillwater, MN (US); Taylor M. Seabaugh, Palo Alto, CA (US)

(21) Appl. No.: 16/965,820

(22) PCT Filed: Jan. 31, 2019
(86) PCT No.: PCT/US2019/016002

§ 371 Date: Jul. 29, 2020

Related U.S. Application Data
(60) Provisional application No. 62/624,332, filed on Jan. 31, 2018.

(51) Int. Cl. E06B 1/62; B32B 3/30; B32B 5/02; B32B 13/14

(52) U.S. Cl. CPC E06B 1/62; B32B 3/30; B32B 5/022; B32B 5/026; B32B 2405/00; E06B 2001/628; B32B 2305/186; B32B 2305/70; B32B 2413/00; B32B 13/14

(57) ABSTRACT

The article includes a first layer having a backing and upstanding posts or fibrous loop protruding from the backing and a second layer of at least one of dried or cured composite including at least one of gypsum, lime, or cement. The fibrous loop includes at least one of arcuate portions projecting from the first surface of the backing web, a knitted fibrous web, or a needle-punched nonwoven web. The upstanding posts may have at least one of the following features: a density of up to 248 per square centimeter, a proximal end attached to the backing and a distal end larger in area than a cross-sectional area of the proximal end with the distal end having overhanging portions extending in at least two opposing directions, or a proximal end attached to the backing and a distal end with no overhanging portion. Methods of making the article are also described.

### CROSS-REFERENCE TO RELATED APPLICATION

This application claims priority to U.S. Provisional Application No. 62/624,332, filed Jan. 31, 2018, the disclosure of which is incorporated by reference in its entirety herein.

### BACKGROUND

Air barrier systems control movement of air, and specifically water vapor, across a surface of a structure, such as a building enclosure. In exterior walls, uncontrolled air flow is the greatest source of moisture and condensation damage. Indoor comfort is affected by air temperature, relative humidity, direction of airflow and surrounding surface temperatures. Indoor air quality is enhanced by air barrier systems that efficiently keep pollutants out of building interiors. Examples of pollutants include water vapor, suspended particulates, dust, insects, and smells. Condensation of water vapor within a wall structure is a key contributor to corrosion and mold growth. Air barrier systems have significant impact on electricity consumption and gas bills. Air barrier systems in nonresidential buildings are estimated to reduce air leakage by up to 83 percent, reduce heating bills more than 40% and reduce electricity consumption more than 25% according to simulations by the National Institute of Standards and Technology (NIST) compared to typical buildings without air barriers. Air barrier systems help prevent water vapor from being transported by air movement between exteriors and interiors of structures, such as buildings.

Flashing tapes are an important part of the overall building envelope that tie into these air barrier membranes at details (i.e. windows, door, penetrations, etc.). Flashing tapes are generally non-permeable to air and water. These products are applied on the exterior sheathing layer of buildings, which is commonly plywood, oriented strand board (OSB), foam insulation sheathing, exterior grade gypsum sheathing board, concrete, concrete masonry units (CMUs), or other conventional sheathing materials commonly used in the construction industry.

U.S. Pat. No. 9,085,899 (Bertrand) describes tapes for affixing one or more geomembrane sheets to a concrete slab. The tape adheres to the one or more geomembrane sheets and includes gripping extensions that include distal ends for embedding into the concrete slab.

### SUMMARY

There are common construction practices around the world for which it would be beneficial for some of the flashing tapes described above to be able to accept mortar, plaster, or cement over the tape backings. Such practices are common in Europe around window and door flashings. Films that accept mortar, plaster, or cement would also be useful in the United States in ‘blindside waterproofing” applications using wider sheet formats.

The present disclosure provides articles and methods that allow composite layers including at least one of gypsum, lime, or cement to be applied to another layer, for example, in building construction. The other layer (first layer as described below) has a backing with upstanding posts or a fibrous loop protruding from the first layer of the backing. The upstanding posts or fibrous loop may be embedded in the composite layer, for example, to improve adhesion to the first layer. The first layer may be part of a flashing tape, a seaming tape, a film for blindside waterproofing, or another construction product.

In one aspect, the present disclosure provides an article that includes a first layer having a backing and upstanding posts or fibrous loop protruding from a first surface of the backing and a second layer of composite including at least one of gypsum, lime, or cement at least one of dried or cured on the first surface of the backing. The fibrous loop includes at least one of a sheet of fibers having arcuate portions projecting from the first surface of the backing, a knitted fibrous web, or a needle-punched nonwoven web. The upstanding posts either have a proximal end attached to the backing and a distal end larger in area than a cross-sectional area of the proximal end with the distal end having overhanging portions extending in at least two opposing directions or a proximal end attached to the backing and a distal end with no overhanging portion.

In another aspect, the present disclosure provides an article that includes a first layer having a backing and upstanding posts or fibrous loop protruding from a first surface of the backing and a second layer of composite including at least one of gypsum, lime, or cement at least one of dried or cured on the first surface of the backing. The fibrous loop includes at least one of a sheet of fibers having arcuate portions projecting from the first surface of the backing, a knitted fibrous web, or a needle-punched nonwoven web. The upstanding posts have a density of up to 248 per square centimeter.

In another aspect, the present disclosure provides a method of making the aforementioned article. The method includes providing the first layer on a substrate, with the second surface of the backing, opposite the first surface, facing the substrate, applying a composition comprising at least one of gypsum, lime, or cement to the first surface of the backing, and at least one of curing or drying the composition to form the composite layer on the first surface of the backing.

In another aspect, the present disclosure provides a method of installing at least one of a door or window. The method includes attaching a first layer comprising a backing and upstanding posts or a fibrous loop protruding from a first surface of the backing to at least a portion of a door or window frame, wherein the fibrous loop comprises at least one of sheet of fibers having arcuate portions projecting from the first surface of the backing, a knitted fibrous web, or a needle-punched nonwoven web, applying a composition comprising at least one of gypsum, lime, or cement to the first surface of the backing; and at least one of curing or drying the composition to form a composite layer on the first surface of the backing.

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated.

The terms “first” and “second” are used in this disclosure in their relative sense only. It will be understood that, unless otherwise noted, those terms are used merely as a matter of convenience in the description of one or more of the embodiments.

The term “upstanding” with regard to the mechanical fastening elements refers to posts that protrude from the thermoplastic backing and includes posts that stand perpendicular to the backing and posts that are at an angle to the backing other than 90 degrees.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

The disclosure may be more completely understood in consideration of the following detailed description of various embodiments of the disclosure in connection with the accompanying drawings, in which:

FIG. 1 is a side view of an embodiment of an article of the present disclosure, wherein the article is adhered to the surface of two different substrates;

FIG. 2 is a cross-sectional view of an embodiment of a first layer useful for practicing the present disclosure;

FIG. 3 is a top view of another embodiment of a first layer useful for practicing the present disclosure, in which the backing has openings therethrough;

FIG. 4 is a perspective view of another embodiment of a first layer useful for practicing the present disclosure, in which the first layer includes a fibrous loop; and

FIG. 5 is a perspective view of another embodiment of a first layer useful for practicing the present disclosure, applied to a window frame.

### DETAILED DESCRIPTION

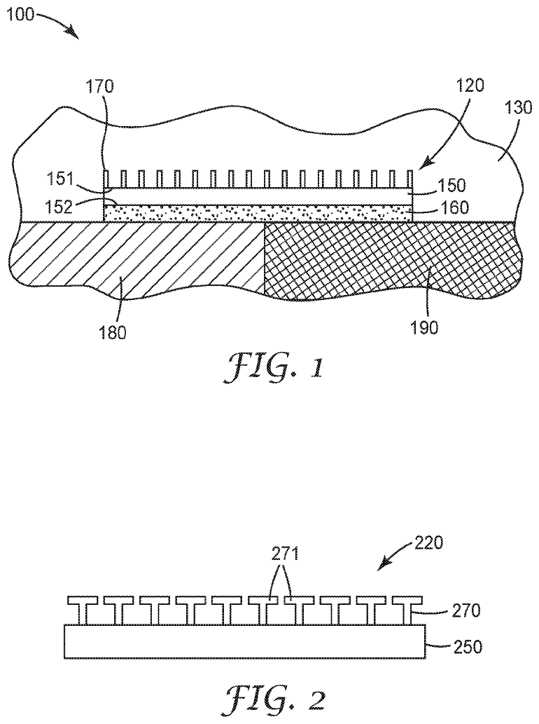

In FIG. 1, an embodiment of an article 100 of the present disclosure is shown. The article 100 has a first layer 120 and a hardened composite layer 130. In the embodiment shown in FIG. 1, an adhesive 160 on the second surface 152 of the backing 150 adheres the first layer 120 to two different substrates 180 and 190. FIG. 1 further shows a plurality of upstanding posts 170 extending from a first surface 151 of the backing 150. The upstanding posts 170 are shown embedded into the hardened composite layer 130. In the illustrated embodiment, the distal ends of the upstanding posts 170 do not have portions that overhang the posts.

The composite layer 130 useful in the article of the present disclosure and illustrated in FIG. 1 can include a variety of materials. In some embodiments, the composite layer includes at least one of aggregate (e.g., sand, gravel, or crushed rock) combined with a binder. The binder can comprise at least one of gypsum, lime, or cement. Examples of useful composite layers include mortar, stucco, plaster, and concrete layers. The composite layer is generally applied as a composition to the first surface of the first layer. The composition further includes water. The composite layer may be at least one of dried (e.g., having the water removed) or cured (e.g., by reaction of the binder).

In FIG. 2, another embodiment of a first layer 220 useful for practicing the present disclosure is shown. The first layer 220 has a backing 250 and upstanding posts 270 protruding from the first surface of the backing 250. In FIG. 2., the upstanding posts 270 have distal caps 271 that are larger in area than the cross-sectional area of the upstanding posts 270.

First layers 120, 220 having upstanding posts 170, 270 on a backing 150, 250 are typically structured films made from thermoplastic materials. Examples of suitable thermoplastic materials include polyolefin homopolymers such as polyethylene and polypropylene, copolymers of ethylene, propylene and/or butylene; copolymers containing ethylene such as ethylene vinyl acetate and ethylene acrylic acid; polyesters such as poly(ethylene terephthalate), polyethylene butyrate, and polyethylene napthalate; polyamides such as poly(hexamethylene adipamide); polyurethanes; polycarbonates; poly(vinyl alcohol); ketones such as polyetheretherketone; polyphenylene sulfide; and mixtures thereof. In some embodiments, the thermoplastic film layer comprises at least one of a polyolefin, a polyamide, or a polyester. In some embodiments, the thermoplastic is a polyolefin (e.g., polyethylene, polypropylene, polybutylene, ethylene copolymers, propylene copolymers, butylene copolymers, and copolymers and blends of these materials).

In a thermoplastic first layer having upstanding posts, the backing 150, 250 and the upstanding posts 170, 270 are integral (that is, generally formed at the same time as a unit, unitary). Upstanding posts on a film can be made, for example, by conventional extrusion through a die and cast molding techniques. In some embodiments, a thermoplastic composition as described in any of the above embodiments is fed onto a continuously moving mold surface with cavities having the inverse shape of the upstanding posts. The thermoplastic composition can be passed between a nip formed by two rolls or a nip between a die face and roll surface, with at least one of the rolls having the cavities (i.e., at least one of the rolls is a tool roll). Pressure provided by the nip forces the thermoplastic composition into the cavities. In some embodiments, a vacuum can be used to evacuate the cavities for easier filling of the cavities. The nip has a gap that is typically large enough such that a coherent film is formed over the cavities. The mold surface and cavities can optionally be air or water cooled before stripping the integrally formed film and upstanding posts from the mold surface such as by a stripper roll.

Suitable tool rolls can be made, for example, by forming (e.g., by computer numerical control with drilling, photo etching, using galvanic printed sleeves, laser drilling, electron beam drilling, metal punching, direct machining, or lost wax processing) a series of holes having the inverse shape of the upstanding posts into the cylindrical face of a metal mold or sleeve. Other suitable tool rolls include those formed from a series of plates defining a plurality of post-forming cavities about its periphery such as those described, for example, in U.S. Pat. No. 4,775,310 (Fischer). Cavities may be formed in the plates by drilling or photoresist technology, for example. Other suitable tool rolls may include wire-wrapped rolls, which are disclosed along with their method of manufacturing, for example, in U.S. Pat. No. 6,190,594 (Gorman et al.). Another example of a method for forming a thermoplastic backing with upstanding posts includes using a flexible mold belt defining an array of upstanding post-shaped cavities as described in U.S. Pat. No. 7,214,334 (Jens et al.). Yet other useful methods for forming a thermoplastic backing with upstanding posts can be found in U.S. Pat. No. 6,287,665 (Hammer), U.S. Pat. No. 7,198,743 (Tuma), and U.S. Pat. No. 6,627,133 (Tuma).

The upstanding posts, which may be made, for example, by any of the methods described above, may have a shape that tapers, for example, from a base portion attached to the film to a distal tip. The base portion may have a larger width dimension than the distal tip, which may facilitate the removal of the post from the mold surface in the methods described above.

The upstanding posts in the first layer disclosed herein may have overhanging portions or may be upstanding posts having distal tips that may or may not be formed into overhanging portions, if desired. In some embodiments, the upstanding posts have distal caps that are larger in area than the cross-sectional area of the upstanding posts. In these embodiments, the upstanding posts may be said to have overhanging portions. Generally, upstanding posts with overhanging portions have a head shape that is different from the shape of the post. For example, the upstanding posts may be in the shape of a mushroom (e.g., with a circular or oval head enlarged with respect to the stem), a palm-tree, a nail, or a T. In some embodiments, overhanging portions extend beyond the post in all directions. In some embodiments, the upstanding posts have overhanging portions on both sides of the post in only one of the x-direction (cross-direction) or the y-direction (machine direction). In some embodiments, the upstanding posts are comprised in hooks. In these embodiments, the upstanding posts may be in the shape of a J.

In some embodiments, the distal tips of the upstanding posts that are formed according to any of the above methods are deformed to form caps with overhangs. A combination heat and pressure, sequentially or simultaneously, may be used to deform the distal tips of the posts to form caps. In some embodiments, deforming comprises contacting the distal tips with a heated surface. The heated surface may be a flat surface or a textured surface such as that disclosed in U.S. Pat. No. 6,708,378 (Parellada et al.) or U.S. Pat. No. 5,868,987 (Kampfer et al.). In some embodiments, wherein the film with upstanding posts is a web of indefinite length, the deforming comprises moving the web in a first direction through a nip having a heated surface member and an opposing surface member such that the heated surface member contacts the distal tips. In these embodiments, the heated surface may be, for example, a capping roll. In some embodiments, the surface used to contact the distal tips is not heated. In these embodiments, the deformation is carried out with pressure and without heating. In some embodiments, the heated surface may be a heated roll opposite a curved support surface forming a variable nip having a variable nip length as described, for example, in U.S. Pat. No. 6,368,097 (Miller et al.). The curved support surface may curve in the direction of the heated roll, and the heated roll may include a feeding mechanism for feeding the film with upstanding posts through the variable nip to compressively engage the web between the heated roll and the support surface.

Another suitable method for forming a thermoplastic film with upstanding posts 170, 270 attached to the backing 150, 250 is profile extrusion, which is described, for example, in U.S. Pat. No. 4,894,060 (Nestegard). In this method a flow stream of a thermoplastic composition is passed through a patterned die lip (e.g., cut by electron discharge machining) to form a web having downweb ridges. The ridges are then transversely sliced at spaced locations along the extension of the ridges to form upstanding posts with a small separation caused by the cutting blade. It should be understood that “upstanding posts” do not include such ridges before they are cut. However, the patterned die lip may be considered a tool to provide a film having upstanding posts on a backing. The separation between the upstanding posts is then increased by stretching the film in the direction of the ridges.

In addition to the continuous methods described above, it is also envisioned that films with upstanding posts can be prepared using batch processes (e.g., single piece injection molding). The film may have any suitable dimension.

The upstanding posts, in any of the embodiments disclosed herein, which may be made, for example, by any of the methods described above, may have a variety of cross-sectional shapes. For example, the cross-sectional shape of the upstanding post may be a polygon (e.g., square, rectangle, hexagon, or pentagon), which may be a regular polygon or not, or the cross-sectional shape of the post may be curved (e.g., round or elliptical).

In some embodiments, the upstanding posts have a maximum height (above the backing) of up to 3 millimeters (mm), 1.5 mm, 1 mm, or 0.5 mm and, in some embodiments, a minimum height of at least 0.05 mm, 0.075 mm, 0.1 mm, or 0.2 mm. In some embodiments, the posts have aspect ratio (that is, a ratio of height over a width dimension) of at least about 2:1, 3:1, or 4:1. The aspect ratio may be, in some embodiments, up to 10:1. For posts with caps, the caps are typically larger in area than the cross-sectional area of the posts. A ratio of a width dimension of the cap to the post measured just below the cap is typically at least 1.5:1 or 3:1 and may be up to 5:1 or greater. The capped posts are typically shorter than the posts before capping. In some embodiments, the capped posts have a height (above the film) of at least 0.025 mm, 0.05 mm, or 0.1 mm and, in some embodiments, up to 2 mm, 1.5 mm, 1 mm, or 0.5 mm. The posts, which may be capped or not, may have a cross-section with a maximum width dimension of up to 1 (in some embodiments, up to 0.75, 0.5, or 0.45) mm. In some embodiments, the posts have a cross-section with a width dimension between 10 μm and 250 μm. The term “width dimension” should be understood to include the diameter of a post with a circular cross-section. When the post has more than one width dimension (e.g., in a rectangular or elliptical cross-section shaped post or a post that tapers as described above), the aspect ratio described herein is the height over the largest width dimension.

The upstanding posts are typically spaced apart on the backing. The term “spaced-apart” refers to posts that are formed to have a distance between them. The bases of “spaced-apart” posts, where they are attached to the film, do not touch each other when the film is in an unbent configuration. In the first layer useful for practicing the present disclosure, the spaced-apart upstanding posts typically have a density of at least 2 per square centimeter (cm²) (13 per square inch (in²)), at least 4 per cm² (26 per in²), or at least 10 per cm² (63 per in²). In some embodiments, the density of the posts may be up to 100/cm² (635/in²), 124/cm² (800/in²), 155/cm² (1000/in²), 186/cm² (1200/in²), 248/cm² (1600/in²), 394/cm² (2500/in²), or 550/cm² (3500/in²). In some embodiments, the density of the posts may be up to 248/cm² (1600/in²), up to about 186/cm² (1200/in²), up to about 100/cm² (635/in²), or up to about 78/cm² (500/in²). The density of the upstanding posts can be in a range from 2/cm² to 248/cm², 4/cm² to 186/cm², or 10/cm² to 100/cm². Densities of up to about 186/cm² can be useful, for example, for allowing the composite composition to flow around the upstanding posts and improve adhesion between the first layer and the composite layer. The spacing of the upstanding posts need not be uniform.

The backing can have a variety of useful thicknesses, including in the range of about 0.00125 to 0.05 centimeters (0.0005 to 0.020 inch) thick and can have generally uniform thickness.

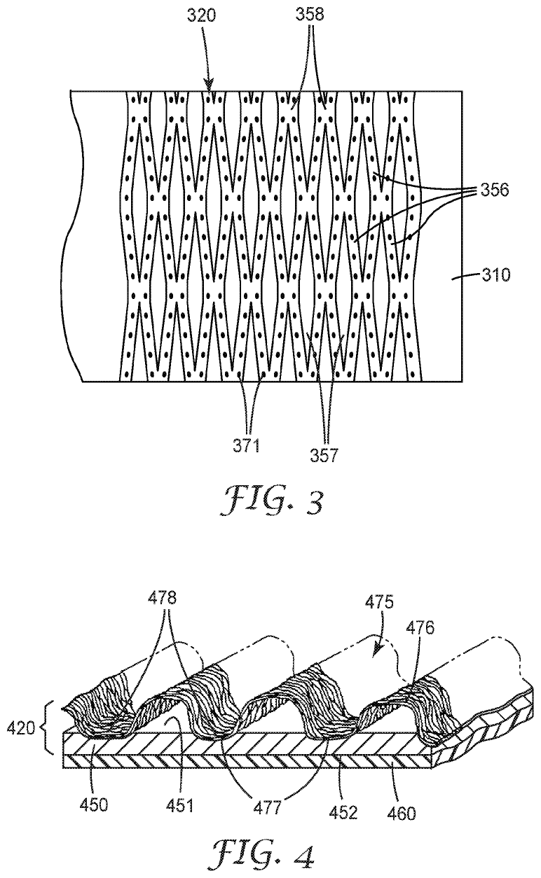

In some embodiments of the first layer useful in the article of the present disclosure, including any of the embodiments described above, the backing does not have perforations therethrough. In other embodiments of the first layer useful in the article of the present disclosure, including any of the embodiments described above, the backing has openings therethrough. FIG. 3 is a top view of a laminate that includes the first layer 320 useful for practicing the present disclosure, in which the backing has openings 357. The openings 357 in the first layer 320 may be in the form of a repeating pattern of geometric shapes such as polygons. The polygons may be, for example, hexagons or quadrilaterals such as parallelograms or diamonds. The openings 357 may be formed in the first layer 320 by any suitable method, including die punching. In some embodiments, the openings may be formed by slitting the thermoplastic backing of the first layer 320 to form multiple strands 356 attached to each other at intact bridging regions 358 in the backing and separating at least some of the multiple strands 356 between at least some of the bridging regions 358. The bridging regions 358 are regions where the backing is not cut through, and at least a portion of the bridging regions can be considered collinear with the slits. The intact bridging regions 358 of the backing serve to divide the slits into a series of spaced-apart slit portions aligned in the direction of slitting (e.g., the machine direction), which can be referred to as interrupted slits. In some embodiments, for at least some adjacent interrupted slits, the spaced-apart slit portions are staggered in a direction transverse to the slitting direction (e.g., the cross-machine direction). The interrupted slits may be cut into the backing between some pairs of adjacent rows of upstanding posts 371 although this is not a requirement. In some embodiments, curved lines may be used, which can result in crescent shaped openings after spreading. There may be more than one repeating pattern of geometric shaped openings. The openings may be evenly spaced or unevenly spaced as desired. For openings that are evenly spaced, the spacing between the openings may differ by up to 10, 5, 2.5, or 1 percent. Further details about providing openings in a mechanical fastener can be found in U.S. Appl. Pub. No. 2012/0204383 (Wood et al.) and U.S. Pat. No. 9,687,048 (Gilbert et al.), U.S. Pat. No. 9,591,896 (Gilbert et al.), and U.S. Pat. No. 9,314,962 (Rothwell et al.). In some embodiments, the fastening patch can comprise multiple strands 356 attached to each other at intact bridging regions 358 in the backing without spreading the strands apart to create openings.

The laminate shown in FIG. 3 illustrates the first layer 320 and a carrier 310 laminated to a second surface of the backing, opposite the first surface from which the upstanding posts or fibrous loops protrude. A carrier laminated to the second surface of the backing may also be useful in any of the first layers of the article described above. The carrier can include a variety of suitable substrates. For example, the carrier may comprise woven webs, non-woven webs (e.g., spunbond webs, spunlaced webs, airlaid webs, meltblown web, and bonded carded webs), textiles, plastic films (e.g., single- or multilayered films, coextruded films, laterally laminated films, or films comprising foam layers), and combinations thereof. In some embodiments, the carrier is a fibrous material (e.g., a woven, nonwoven, or knit material). The term “non-woven” refers to a material having a structure of individual fibers or threads that are interlaid but not in an identifiable manner such as in a knitted fabric. In some embodiments, the carrier comprises multiple layers of nonwoven materials with, for example, at least one layer of a meltblown nonwoven and at least one layer of a spunbonded nonwoven, or any other suitable combination of nonwoven materials. For example, the carrier may be a spunbond-meltblown-spunbond, spunbond-spunbond, or spunbond-spunbond-spunbond multilayer material. Or, the carrier may be a composite web comprising any combination of nonwoven layers and dense film layers. The carrier may be continuous (i.e., without any through-penetrating holes) or discontinuous (e.g. comprising through-penetrating perforations or pores) and may or may not have a different color from the first layer.

Fibrous materials that provide useful carriers for the first layer in the article of the present disclosure may be made of natural fibers (e.g., wood or cotton fibers), synthetic fibers (e.g., thermoplastic fibers), or a combination of natural and synthetic fibers. Examples of materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The fibers may also be multi-component fibers, for example, having a core of one thermoplastic material and a sheath of another thermoplastic material.

Useful carriers may have any suitable basis weight or thickness that is desired for a particular application. For a fibrous carrier, the basis weight may range, e.g., from at least about 20, 30, or 40 grams per square meter, up to about 400, 200, or 100 grams per square meter. The carrier may be up to about 5 mm, about 2 mm, or about 1 mm in thickness and/or at least about 0.1, about 0.2, or about 0.5 mm in thickness.

For any of the carriers described herein, the first layer and the carrier can be joined by extrusion lamination, adhesives (e.g., pressure sensitive adhesives), or other bonding methods (e.g., ultrasonic bonding, compression bonding, or surface bonding).

In some embodiments bonding the first layer to the carrier can be carried out using high-temperature impingement fluid as described in U.S. Pat. No. 9,096,960 (Biegler et al.), U.S. Pat. No. 9,126,224 (Biegler et al.), and U.S. Pat. No. 8,956,496 (Biegler et al.). In some embodiments, the high-temperature fluid is a high-temperature gas (e.g., air, dehumidified air, nitrogen, an inert gas, a mixture of any of these, or another gas mixture). In some embodiments, the high-temperature fluid is high-temperature air. In some embodiments, joining the first layer to the carrier (in some embodiments, a fibrous web) comprises at least one of impinging heated gaseous fluid onto a first surface of the carrier while it is moving or impinging heated gaseous fluid onto a second surface of the first layer while it is moving, wherein the second surface is opposite the first surface having the upstanding posts. Joining the first layer to the carrier typically further includes contacting the first surface of the carrier with the second surface of the first layer so that the two surfaces are melt-bonded. When heated gaseous fluid is impinged on both the carrier and the first layer, the heated gaseous fluid can be applied sequentially or simultaneously. The high-temperature fluid can be directed toward the second surface of the first layer only, or the high-temperature fluid can be directed toward the first surface of the carrier only.

When the carrier is a fibrous web, using high-temperature impingement fluid to join the carrier and the first layer can be carried out such that the carrier is surface bonded to the first layer. The term “surface-bonded” when referring to the bonding of fibrous materials means that parts of fiber surfaces of at least portions of fibers are melt-bonded to the surface of the first layer in such a manner as to substantially preserve the original (pre-bonded) shape of the surface of the first layer, and to substantially preserve at least some portions of the surface of the fibrous web in an exposed condition, in the surface-bonded area. Quantitatively, surface-bonded fibers may be distinguished from embedded fibers in that at least about 65% of the surface area of the surface-bonded fiber is visible above the surface of the second surface of the first layer in the bonded portion of the fiber. Inspection from more than one angle may be necessary to visualize the entirety of the surface area of the fiber. The term “loft-retaining bond” when referring to the bonding of fibrous materials means a bonded fibrous material comprises a loft that is at least 80% of the loft exhibited by the material before, or in the absence of, the bonding process. The loft of a fibrous material as used herein is the ratio of the total volume occupied by the web (including fibers as well as interstitial spaces of the material that are not occupied by fibers) to the volume occupied by the material of the fibers alone. If only a portion of a fibrous web has the surface of the first layer bonded thereto, the retained loft can be easily ascertained by comparing the loft of the fibrous web in the bonded area to that of the web in an unbonded area. It may be convenient in some circumstances to compare the loft of the bonded web to that of a sample of the same web before being bonded, for example, if the entirety of fibrous web has the surface of the first layer bonded thereto.

In some embodiments of the first layer useful in the article of the present disclosure, the first layer comprises a backing and fibrous loop protruding from the backing. The loops may be part of a fibrous structure formed by any of several methods such as weaving, knitting, warp knitting, weft insertion knitting, circular knitting, or methods for making nonwoven structures. In some embodiments, the loops are included in a nonwoven web or a knitted web. Examples of non-woven webs include spunbond webs, spunlaced webs, airlaid webs, meltblown web, and bonded carded webs. Useful loop materials may be made of natural fibers (e.g., wood or cotton fibers), synthetic fibers (e.g., thermoplastic fibers), or a combination of natural and synthetic fibers. Examples of suitable materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The fibers may also be multi-component fibers, for example, having a core of one thermoplastic material and a sheath of another thermoplastic material.

Examples of suitable first layers having fibrous loop are disclosed, for example, in U.S. Pat. No. 5,389,416 (Mody et al.) and U.S. Pat. No. 5,256,231 (Gorman et al.) and EP 0,341,993 (Gorman et al.). As described in U.S. Pat. No. 5,256,231 (Gorman et al.), the fibrous layer in a loop material according to some embodiments can comprise arcuate portions projecting in the same direction from spaced anchor portions on a film. Any of the fibrous loop materials may be extrusion-bonded, adhesive-bonded, and/or sonically-bonded to the backing.

An embodiment of a first layer 420 having a fibrous loop protruding from the first surface of a backing is shown in FIG. 4. Generally, the first layer 420 has a backing 450 with first and second major surfaces 451 and 452, respectively, and a sheet of fibers 475 having generally non-deformed anchor portions 477 bonded by being embedded in the backing layer 450 at spaced elongate generally parallel bonding locations 478 with arcuate portions 476 of the sheet of fibers 475 projecting from the first surface 451 of the backing 450 between the bonding locations 478. The bonding locations 478 and arcuate portions 476 typically alternate and are continuous in one direction along the front surface 451 of backing 450.

Suitable materials for the backing 450 include any of those described above for the thermoplastic backing having upstanding posts. The backing 450 can have a variety of useful thicknesses, including in the range of about 0.00125 to 0.05 centimeters (0.0005 to 0.020 inch) thick and can have generally uniform morphology. The arcuate portions 476 of the sheet of fibers 475 can have a generally uniform height from the backing 450 of up to about 0.64 centimeters (0.250 inch) and, in some embodiments, less than about 0.381 centimeters (0.150 inch). The height of the formed sheet of fibers 475 is typically at least one-third, and, in some embodiments, 0.5 to 1.5 times the distance between the bonding locations 478. The individual fibers in the sheet of fibers 475 are typically less than 25 denier (in some embodiments, in the range of 1 to 10 denier) in size, and the sheet of fibers 475 without the backing 450 typically has a basis weight in the range of 5 to 300 grams per square meter (and in some embodiments in the range of 15 to 100 grams per square meter) measured along the first surface 451.

The fibers in the sheet of fibers 475 can be disposed in various directions with respect to the parallel bonding locations 478 and may or may not be bonded together at crossover points in the arcuate portions 476; can be disposed in various directions with respect to the parallel bonding locations 478 with the majority of the fibers in the sheet of fibers 475 (i.e., over 80 or 90 percent) extending in directions at about a right angle to the bonding locations 478; or all of the individual fibers in the sheet of fibers 475 can extend in directions generally at right angles to the spaced generally parallel bonding locations 478. Arcuate portions in a sheet of fibers can be made in a fibrous web using corrugating members, for example.

As shown in Example 9, below, a fibrous loop having arcuate portions projecting from the first major surface of the backing, such as that illustrated in FIG. 4, provides better adhesion to a concrete layer than tapes including only fleece or certain spunbond nonwovens. It is expected that the structure of a knitted fibrous web or a needle punched fibrous web would also provide better adhesion to composite layers because of the ability of the composite to surround the fibers in these constructions. An example of a needle-punched nonwoven web suitable as a first layer in an article of the present disclosure is described in U.S. Pat. No. 6,342,285 (Shepard et al.). Hydroentangling nonwoven fabrics may also provide suitable fibrous loop structures.

In some embodiments, including embodiments illustrated in FIGS. 1 and 4, the article further comprises an adhesive 160, 460 on a second surface of the backing 152, 452 of the first layer 150, 450, opposite the first surface 151, 451 from which the upstanding posts or fibrous loop protrudes. In other embodiments, the article further comprises an adhesive on a surface of the carrier opposite the second surface of the backing. The carrier can be any of those described above. The adhesive on either the second surface of the backing or the carrier can be a pressure sensitive adhesive (PSA). PSAs are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power.

One method useful for identifying pressure sensitive adhesives is the Dahlquist criterion. This criterion defines a pressure sensitive adhesive as an adhesive having a creep compliance of greater than 3×10⁻⁶ cm²/dyne as described in Handbook of Pressure Sensitive Adhesive Technology, Donatas Satas (Ed.), 2nd Edition, p. 172, Van Nostrand Reinhold, New York, N.Y., 1989. Alternatively, since modulus is, to a first approximation, the inverse of creep compliance, pressure sensitive adhesives may be defined as adhesives having a storage modulus of less than about 3×10⁵ N/m².

A variety of PSAs may be useful on the article of the present disclosure. Examples of suitable PSAs include natural rubber-, acrylic-, block copolymer-, silicone-, polyisobutylene-, polyvinyl ether-, polybutadiene-, or and urea-based pressure sensitive adhesive and combinations thereof. These PSAs can be prepared, for example, as described in Adhesion and Adhesives Technology, Alphonsus V. Pocius, Hanser/Gardner Publications, Inc., Cincinnati, Ohio, 1997, pages 216 to 223; Handbook of Pressure Sensitive Adhesive Technology, Donatas Satas (Ed.), 2nd Edition, Van Nostrand Reinhold, New York, N.Y., 1989, Chapter 15; and U.S. Pat. No. Re 24,906 (Ulrich). Another example of a pressure sensitive adhesive useful in assembling architectural structures (e.g., buildings) is a rubber modified asphalt (bitumen) pressure sensitive adhesive or a synthetic rubber pressure sensitive adhesive.

In some embodiments, the adhesive is selected to be a solventless or hot melt adhesive. In some embodiments, solvent based adhesives or water based adhesives may be used. Examples of suitable adhesives include radiation-cured (e.g., ultraviolet (UV) radiation or electron-beam cured (co)polymers resulting from polymerizable monomers or oligomers) may be used. Suitable hot melt adhesives may contain (co)polymers such as butyl rubber, styrene-butadiene-styrene (SBS), styrene-isoprene-styrene (SIS), styrene butadiene (SB), styrene-ethylene-butadiene-styrene (SEBS), and ethylene/vinylacetate (EVA). Tackifying resins, which generally refer to materials that are compatible with the elastomer and have a number average molecular weight of up to 10,000 grams per mole, are typically added to these elastomers. Useful tackifying resins can have a softening point of at least 70° C. as determined using a ring and ball apparatus and a glass transition temperature of at least −30° C. as measured by differential scanning calorimetry. In some embodiments, the tackifying resin comprises at least one of rosin, a polyterpene (e.g., those based on α-pinene, β-pinene, or limonene), an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g. those based on styrene, α-methyl styrene, methyl indene, indene, coumarone, or combinations thereof), or a mixed aliphatic-aromatic hydrocarbon resin. Any of these tackifying resins may be hydrogenated (e.g., partially or completely). Natural and petroleum waxes, oil, and bitumen may be useful as additives to the pressure sensitive adhesive composition.

In some embodiments, PSAs compositions that are useful in the article and method according to the present disclosure are acrylic PSAs. As used herein, the term “acrylic” or “acrylate” includes compounds having at least one of acrylic or methacrylic groups. Useful acrylic PSAs can be made, for example, by combining at least two different monomers. Examples of suitable first monomers include 2-methylbutyl acrylate, 2-ethylhexyl acrylate, isooctyl acrylate, lauryl acrylate, n-decyl acrylate, 4-methyl-2-pentyl acrylate, isoamyl acrylate, sec-butyl acrylate, isononyl acrylate, and methacrylates of the foregoing acrylates. Examples of suitable second monomers useful for preparing acrylic PSAs include a (meth)acrylic acid (e.g., acrylic acid, methacrylic acid, itaconic acid, maleic acid, and fumaric acid), a (meth)acrylamide (e.g., acrylamide, methacrylamide, N-ethyl acrylamide, N-hydroxyethyl acrylamide, N-octyl acrylamide, N-t-butyl acrylamide, N,N-dimethyl acrylamide, N,N-diethyl acrylamide, N-ethyl-N-dihydroxyethyl acrylamide, and methacrylamides of the foregoing acrylamides), a (meth)acrylate (e.g., 2-hydroxyethyl acrylate or methacrylate, cyclohexyl acrylate, t-butyl acrylate, isobornyl acrylate, and methacrylates of the foregoing acrylates), N-vinyl pyrrolidone, N-vinyl caprolactam, an alpha-olefin, a vinyl ether, an allyl ether, a styrenic monomer, or a maleate. In some embodiments, the PSA in the composition according to the present disclosure includes a pendent carboxylic acid group incorporated into the PSA by including, for example, acrylic acid, methacrylic acid, itaconic acid, maleic acid, or fumaric acid in the preparation of the PSA.

Acrylic PSAs may also be made by including cross-linking agents in the formulation. Examples of cross-linking agents include copolymerizable polyfunctional ethylenically unsaturated monomers (e.g., 1,6-hexanediol diacrylate, trimethylolpropane triacrylate, pentaerythritol tetraacrylate, and 1,2-ethylene glycol diacrylate); ethylenically unsaturated compounds which in the excited state are capable of abstracting hydrogen (e.g., acrylated benzophenones such as described in U.S. Pat. No. 4,737,559 (Kellen et al.), p-acryloxy-benzophenone, which is available from Sartomer Company, Exton, Pa., monomers described in U.S. Pat. No. 5,073,611 (Rehmer et al.) including p-N-(methacryloyl-4-oxapentamethylene)-carbamoyloxybenzophenone, N-(benzoyl-p-phenylene)-N′-(methacryloxymethylene)-carbodiimide, and p-acryloxy-benzophenone); nonionic crosslinking agents which are essentially free of olefinic unsaturation and is capable of reacting with carboxylic acid groups, for example, in the third monomer described above (e.g., 1,4-bis(ethyleneiminocarbonylamino)benzene; 4,4-bis(ethyleneiminocarbonylamino)diphenylmethane; 1,8-bis(ethyleneiminocarbonylamino)octane; 1,4-tolylene diisocyanate; 1,6-hexamethylene diisocyanate, N,N′-bis-1,2-propyleneisophthalamide, diepoxides, dianhydrides, bis(amides), and bis(imides)); and nonionic crosslinking agents which are essentially free of olefinic unsaturation, are noncopolymerizable with the first and second monomers, and, in the excited state, are capable of abstracting hydrogen (e.g., 2,4-bis(trichloromethyl)-6-(4-methoxy)phenyl)-s-triazine; 2,4-bis(trichloromethyl)-6-(3,4-dimethoxy)phenyl)-s-triazine; 2,4-bis(trichloromethyl)-6-(3,4,5-trimethoxy)phenyl)-s-triazine; 2,4-bis(trichloromethyl)-6-(2,4-dimethoxy)phenyl)-s-triazine; 2,4-bis(trichloromethyl)-6-(3-methoxy)phenyl)-s-triazine as described in U.S. Pat. No. 4,330,590 (Vesley); 2,4-bis(trichloromethyl)-6-naphthenyl-s-triazine and 2,4-bis(trichloromethyl)-6-(4-methoxy)naphthenyl-s-triazine as described in U.S. Pat. No. 4,329,384 (Vesley)).

Typically, the first monomer is used in an amount of 80-100 parts by weight (pbw) based on a total weight of 100 parts of copolymer, and a second monomer as described above is used in an amount of 0-20 pbw based on a total weight of 100 parts of copolymer. The crosslinking agent can be used in an amount of 0.005 to 2 weight percent based on the combined weight of the monomers, for example from about 0.01 to about 0.5 percent by weight or from about 0.05 to 0.15 percent by weight.

The acrylic PSAs useful for practicing the present disclosure can be prepared, for example, in solvent or by a solvent free, bulk, free-radical polymerization process (e.g., using heat, electron-beam radiation, or ultraviolet radiation). Such polymerizations are typically facilitated by a polymerization initiator (e.g., a photoinitiator or a thermal initiator). The polymerization initiator is used in an amount effective to facilitate polymerization of the monomers (e.g., 0.1 part to about 5.0 parts or 0.2 part to about 1.0 part by weight, based on 100 parts of the total monomer content).

If a photocrosslinking agent is used, the coated adhesive can be exposed to ultraviolet radiation having a wavelength of about 250 nm to about 400 nm. The radiant energy in this range of wavelength required to crosslink the adhesive is about 100 millijoules/cm² to about 1,500 millijoules/cm2, or more specifically, about 200 millijoules/cm² to about 800 millijoules/cm².

A useful solvent-free polymerization method is disclosed in U.S. Pat. No. 4,379,201 (Heilmann et al.). Initially, a mixture of first and second monomers can be polymerized with a portion of a photoinitiator by exposing the mixture to UV radiation in an inert environment for a time sufficient to form a coatable base syrup, and subsequently adding a crosslinking agent and the remainder of the photoinitiator. This final syrup containing a crosslinking agent (e.g., which may have a Brookfield viscosity of about 100 centipoise to about 6000 centipoise at 23° C., as measured with a No. 4 LTV spindle, at 60 revolutions per minute) can then be coated onto a substrate, for example, a polymeric film substrate. Once the syrup is coated onto the substrate, for example, the polymeric film substrate, further polymerization and crosslinking can be carried out in an inert environment (e.g., nitrogen, carbon dioxide, helium, and argon, which exclude oxygen). A sufficiently inert atmosphere can be achieved by covering a layer of the photoactive syrup with a polymeric film, such as silicone-treated PET film, that is transparent to UV radiation or e-beam and irradiating through the film in air.

Solvent-based adhesives may contain ingredients such as those listed above, dissolved or dispersed in a solvent vehicle. Water based adhesives would normally be based on emulsions of (co)polymeric materials. Suitable (co)polymeric materials include vinyl acetate and (meth)acrylic homopolymers and copolymers.

In some embodiments, the article of the present disclosure and/or made by the methods disclosed herein includes a substrate. The substrate can be made from a variety of materials such as wood, vinyl, metal, or concrete. Referring again to FIG. 1, the first layer 120 can be adhered to two different substrates 180 and 190. Useful substrates can include at least one of an air and water barrier film, a subfloor, a window frame, a door frame, and wall sheathing materials (e.g., oriented strand board (OSB), foam insulation sheathing, exterior grade gypsum sheathing board, concrete, concrete masonry units (CMUs)). The substrate, in some cases, can be compacted soil or gravel. The substrate may be horizontal or vertical. In some embodiments, the article of the present disclosure and/or made by the methods disclosed herein is at least a portion of an interior wall, an exterior wall, a floor, a ceiling, or a roof.

In some embodiments, the article of the present disclosure is a heated floor. Electrical heating elements, for example, can be installed on a subfloor underneath the first layer of the article of the present disclosure or can be installed between the first layer and the composite layer of the article. When the electrical heating elements are placed between the first layer and the composite layer, it is possible that the heating element structure fits in the spaces between the upstanding posts or the arcuate portions of the fibrous web, for example.

A method of the present disclosure includes providing the first layer on a substrate, with the second surface of the backing, opposite the first surface, facing the substrate, applying a composition comprising at least one of gypsum, lime, or cement to the first surface of the backing, and at least one of curing or drying the composition to form the composite layer on the first surface of the backing. The substrates can be any of those described above.

In some embodiments, the method includes “blindside” (also called pre-applied) waterproofing. In this technique, the first layer can be affixed to the concrete form or lagging with the second surface of the backing against the lagging and the first surface from which the upstanding posts or fibrous loop projects facing toward the cavity into which the concrete is poured. The upstanding posts or fibrous loop will become embedded in the concrete and remain fixed in the concrete after the form or lagging is removed. The backing of the first layer may be a sufficient air and water barrier layer and may be impermeable to vapor and liquid. In some embodiments, the second surface of the first layer can be adhered to another air and water barrier layer on the lagging.

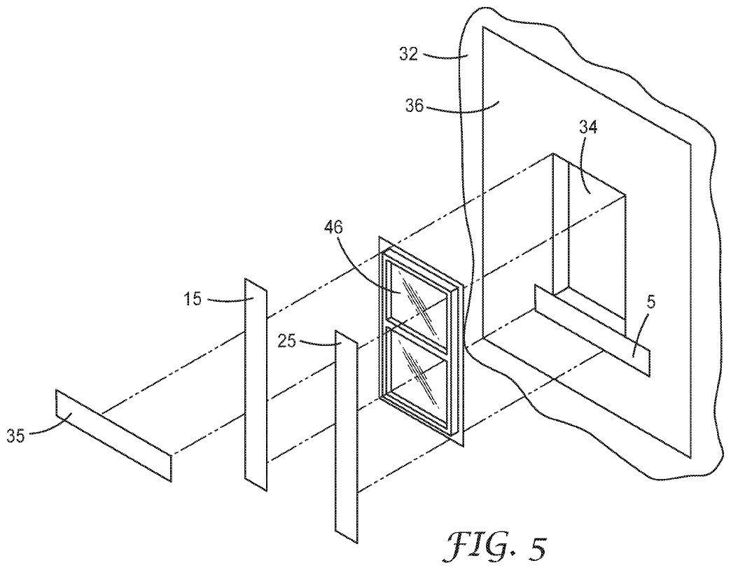

The present disclosure also provides a method of installing a window or door. FIG. 5 is a perspective, exploded view of an embodiment of a first layer useful for practicing the present disclosure, applied to a window frame. FIG. 5 illustrates a window opening 34 in wall sheathing 32 that is optionally covered with building wrap 36. Suitable materials for wall sheathing include plywood, oriented strand board (OSB), foam insulation sheathing, exterior grade gypsum sheathing board, concrete, concrete masonry units (CMUs), and other conventional sheathing materials commonly used in the construction industry. As shown in FIG. 5, first layer 5, as described in any of the above embodiments, is applied on building wrap 36 or wall sheathing 32 level with the bottom edge of the rough opening frame 34 to form a sill flashing. Window sill pans may be installed in the opening and the first layer 5 can overlap the sill pan. Window 46 is inserted into opening 34. Typically, the window frame fits within the opening and flanges extend from the window frame and over the wall sheathing. The window flanges are secured to the wall. First layers 15 and 25 can also be applied on the window jambs extending from the window flange and onto the building wrap 36 or wall sheathing 32. First layer 35 can also be applied at the top flange on the window and the sheathing. Cutting a flap of building wrap 36 to expose the wall sheathing 32 can allow clearance for the first layer 35 at the top of the window. Then a composite composition (e.g., mortar, stucco, plaster, or concrete) can be applied over the sheathing, building wrap, and first layers to provide an embodiment of an article of the present disclosure.

In some embodiments, the substrate for the article of the present disclosure and/or made according to the method of the present disclosure includes an air and water barrier film. The air and water barrier film can be, for example, a building wrap as described above or a membrane used under a concrete floor or on an interior wall. In some embodiments in which the article of the present disclosure includes an air and water barrier, the first layer of the article can be useful as seaming tape or flashing tape, for example. The term “air and water barrier” as used herein means material that is designed and constructed to provide the principal plane of air tightness through an environmental separator and that has an air permeance rate no greater than 0.02 L per square meter per second at a pressure difference of 75 Pa when tested in accordance with ASTM E 2178-13 and provides acceptable barrier performance with respect to water according to AATCC 127-2013. In some embodiments, the air and water barrier is impermeable to liquid water at 55 cm of water pressure. In some embodiments, the air and water barrier film is water vapor impermeable. In other embodiments, the air and water barrier film is water vapor permeable. The term “water vapor permeable” as used herein means an article having a permeance of more than 1 perm (inch-pounds units) according to ASTM E 96 Procedure A (Desiccant Method). Likewise, water vapor impermeable refers to articles having a permeance of less than 1 perm.

In some embodiments, the air and water barrier film is water vapor permeable and includes a porous layer. In some embodiments, the porous layer is microporous membrane. Suitable microporous membranes include thermally induced phase separated porous membranes such as that described in U.S. Pat. No. 5,120,594 (Mrozinski). Such membranes are commercially available under the trade designation “ProPore” from 3M Company, St. Paul, Minn. Suitable microporous membranes also include stretched calcium carbonate filled polyolefin film as described in U.S. Pat. No. 4,923,650 (Antoon). Such membranes are commercially available under the trade designation “Micropro” from Clopay Plastics, Mason, Ohio. Suitable microporous membranes preferably spunbonded or fibrous bonded polyolefin as described in U.S. Pat. No. 3,532,589 (David) and U.S. Pat. No. 5,972,147 (Janis). In some instances, the polyolefins (e.g., polyethylene and polypropylene) are cast, annealed and then stretched. One suitable microporous membrane is commercially available under the trade designation “TYVEK” from E.I. DuPont deNemours Corp., Wilmington, Del. Other suitable microporous membranes include oriented polymeric films as described in U.S. Pat. No. 5,317,035 (Jacoby et al.), and which comprise ethylene-propylene block copolymers. Such membranes are commercially available under the trade designation “APTRA films” from BP-Amoco Corp., Atlanta, Ga. Suitable microporous membranes can be formed from immiscible polymer materials or polymer materials that have an extractable component, such as solvent. These materials are stretched after casting. In some embodiments, the water vapor permeable air and water barrier film includes a water vapor permeable polymeric layer disposed on a first major surface of a porous layer. The polymeric layer may at least one of completely cover or impregnate the porous layer. In some of these embodiments, the polymeric layer is crosslinked. In some embodiments, the polymeric layer comprises a polyoxyalkylene polymer having at least one crosslink site derived from an alkoxy silane. The porous layer having the polymeric layer thereon may be any of the materials described above as carriers for the first layer. In some embodiments, the water vapor permeable air and water barrier film is as described in Int. Pat. Appl. Pub. Nos. WO 2015/183354 (Widenbrant), WO 2015/126931 (Seabaugh), WO 2017/031275 (Widenbrant), WO 2017/031359 (Widenbrant), and WO 2017/112756 (Seabaugh).

The first layer useful in the article according to the present disclosure can have a wide variety of widths. If the first layer is a component of a flashing tape, it is typically between 2 inches (5.1 cm) and 12 inches (30.5 cm) in width. For blindside waterproofing, the width can be up to 60 inches (152 cm) or more. In some embodiments, the width of the first layer is at least 2.5 centimeters. In some embodiments, the width of the first layer is at least 5 centimeters. In some embodiments, the width of the first layer is at most 10 centimeters. In some embodiments, the width of the first layer is up to 45 centimeters or up to 75 centimeters.

Some Embodiments of the Disclosure

In a first embodiment, the present disclosure provides an article comprising:

a first layer comprising a backing and upstanding posts or a fibrous loop protruding from a first surface of the backing, wherein the fibrous loop comprises at least one of a sheet of fibers having arcuate portions projecting from the first surface of the backing, a knitted fibrous web, or a needle-punched nonwoven web, and wherein the upstanding posts have a proximal end attached to the backing and a distal end larger in area than a cross-sectional area of the proximal end with the distal end having overhanging portions extending in at least two opposing directions, or wherein the upstanding posts have a proximal end attached to the backing and a distal end with no overhanging portion; and

a composite layer comprising at least one of gypsum, lime, or cement, wherein the composite layer is at least one of dried or cured on the first surface of the backing.

In a second embodiment, the present disclosure provides an article comprising:

a first layer comprising a backing and upstanding posts at a density of up to 248 per square centimeter or a fibrous loop protruding from a first surface of the backing, wherein the fibrous loop comprises at least one of a sheet of fibers having arcuate portions projecting from the first surface of the backing, a knitted fibrous web, or a needle-punched nonwoven web; and

a composite layer comprising at least one of gypsum, lime, or cement, wherein the composite layer is at least one of dried or cured on the first surface of the backing.

In a third embodiment, the present disclosure provides the article of the first or second embodiment, wherein at least a portion of the upstanding posts or the fibrous loop is embedded in the composite layer.

In a fourth embodiment, the present disclosure provides the article of any one of the first to third embodiments, wherein first surface of the backing has a density of upstanding posts of up to 186 per square centimeter.

In a fifth embodiment, the present disclosure provides the article of any one of the first to fourth embodiments, wherein first surface of the backing has a density of upstanding posts of up to 124 per square centimeter.

In a sixth embodiment, the present disclosure provides the article of any one of the first to fifth embodiments, wherein first surface of the backing has a density of upstanding posts of up to 100 per square centimeter.

In a seventh embodiment, the present disclosure provides the article of any one of the second to sixth embodiments, wherein the first layer comprises the upstanding posts protruding from the first surface of the backing, and wherein the upstanding posts are comprised in hooks.

In an eighth embodiment, the present disclosure provides the article of any one of the first to sixth embodiments, wherein the first layer comprises the upstanding posts protruding from the first surface of the backing, and wherein the upstanding posts have a proximal end attached to the backing and a distal end with no overhanging portion.

In a ninth embodiment, the present disclosure provides the article of any one of the first to sixth embodiments, wherein the first layer comprises the upstanding posts protruding from the first surface of the backing, and wherein the upstanding posts have a proximal end attached to the backing and a distal cap larger in area than a cross-sectional area of the proximal end with the distal cap having overhanging portions extending in at least two opposing directions.

In a tenth embodiment, the present disclosure provides the article of the ninth embodiment, wherein upstanding posts have mushroom-shaped caps.

In an eleventh embodiment, the present disclosure provides the article of any one of the first to third embodiments, wherein the first layer comprises the fibrous loop protruding from the first surface of the backing, and wherein the fibrous loop comprises at least one of the knitted fibrous web or the sheet of fibers having arcuate portions projecting from the first surface of the backing.

In a twelfth embodiment, the present disclosure provides the article of the eleventh embodiment, wherein the first layer comprises the fibrous loop protruding from the first surface of the backing, and wherein the fibrous loop comprises the sheet of fibers having arcuate portions projecting from the first surface of the backing.

In a thirteenth embodiment, the present disclosure provides the article of any one of the first to twelfth embodiments, wherein the backing does not have perforations therethrough.

In a fourteenth embodiment, the present disclosure provides the article of any one of the first to twelfth embodiments, wherein the backing has openings therethrough.

In a fifteenth embodiment, the present disclosure provides the article of any one of the first to fourteenth embodiments, wherein the backing has an average thickness of up to 510 micrometers.

In a sixteenth embodiment, the present disclosure provides the article of any one of the first to fifteenth embodiments, wherein the backing comprises at least one of a polyolefin, polyamide, or polyester.

In a seventeenth embodiment, the present disclosure provides the article of any one of the first to sixteenth embodiments, wherein the backing comprises at least one of polypropylene or polyethylene.

In an eighteenth embodiment, the present disclosure provides the article of any one of the first to seventeenth embodiments, wherein the backing has stretch-induced molecular orientation in at least one direction.

In a nineteenth embodiment, the present disclosure provides the article of any one of the first to eighteenth embodiments, further comprising a carrier laminated to a second surface of the backing, opposite the first surface.

In a twentieth embodiment, the present disclosure provides the article of the nineteenth embodiment, wherein the carrier comprises at least one of a nonwoven material, a knit material, or a film.

In a twenty-first embodiment, the present disclosure provides the article of the nineteenth or twentieth embodiment, further comprising an adhesive on a surface of the carrier opposite the second surface of the backing.

In a twenty-second embodiment, the present disclosure provides the article of any one of the first to eighteenth embodiments, further comprising an adhesive on a second surface of the backing, opposite the first surface.

In a twenty-third embodiment, the present disclosure provides the article of the twenty-first or twenty-second embodiment, wherein the adhesive is a pressure sensitive adhesive.

In a twenty-fourth embodiment, the present disclosure provides a method of making the article of any one of the first to twenty-third embodiments, the method comprising:

providing the first layer on a substrate, with the second surface of the backing, opposite the first surface, facing the substrate;

applying a composition comprising at least one of gypsum, lime, or cement to the first surface of the backing; and

at least one of curing or drying the composition to form the composite layer on the first surface of the backing.

In a twenty-fifth embodiment, the present disclosure provides the method of the twenty-fourth embodiment, wherein the substrate comprises at least one of an air and water barrier film, a subfloor, a window frame, or a door frame.

In a twenty-sixth embodiment, the present disclosure provides the method of the twenty-fourth or twenty-fifth embodiment, wherein the substrate comprises a window frame or a door frame.

In a twenty-seventh embodiment, the present disclosure provides the method of any one of the twenty-fourth to twenty-sixth embodiments, wherein the substrate comprises at least one of wood, vinyl, metal, or concrete.

In a twenty-eighth embodiment, the present disclosure provides the method of any one of the twenty-fourth to twenty-seventh embodiments, wherein the first layer is adhered to the substrate.

In a twenty-ninth embodiment, the present disclosure provides the method of any one of the twenty-fourth to twenty-eighth embodiments, wherein the composition further comprises at least one of water or aggregate.

In a thirtieth embodiment, the present disclosure provides the method of any one of the twenty-fourth to twenty-ninth embodiments, wherein the composition comprises lime.

In a thirty-first embodiment, the present disclosure provides the method of any one of the twenty-fourth to thirtieth embodiments, wherein the article is an interior wall, an exterior wall, a floor, a ceiling, or a roof.

In a thirty-second embodiment, the present disclosure provides a method of installing at least one of a door or window, the method comprising:

attaching a first layer comprising a backing and upstanding posts or a fibrous loop protruding from a first surface of the backing to at least a portion of a door or window frame, wherein the fibrous loop comprises at least one of a sheet of fibers having arcuate portions projecting from the first surface of the backing, a knitted fibrous web, or a needle-punched nonwoven web;

applying a composition comprising at least one of gypsum, lime, or cement to the first surface of the backing; and

at least one of curing or drying the composition to form a composite layer on the first surface of the backing.

In a thirty-third embodiment, the present disclosure provides the method of the thirty-second embodiment, wherein at least a portion of the upstanding posts or the fibrous loop is embedded in the composite layer.

In a thirty-fourth embodiment, the present disclosure provides the method of any one of the thirty-second or thirty-third embodiments, wherein first surface of the backing has a density of upstanding posts of up to 186 per square centimeter.

In a thirty-fifth embodiment, the present disclosure provides the method of any one of the thirty-second to thirty-fourth embodiments, wherein first surface of the backing has a density of upstanding posts of up to 124 per square centimeter.

In a thirty-sixth embodiment, the present disclosure provides the method of any one of the thirty-second to thirty-fifth embodiments, wherein first surface of the backing has a density of upstanding posts of up to 100 per square centimeter.

In a thirty-seventh embodiment, the present disclosure provides the method of any one of the thirty-second to thirty-sixth embodiments, wherein the first layer comprises the upstanding posts protruding from the first surface of the backing, and wherein the upstanding posts are comprised in hooks.

In a thirty-eighth embodiment, the present disclosure provides the method of any one of the thirty-second to thirty-sixth embodiments, wherein the first layer comprises the upstanding posts protruding from the first surface of the backing, and wherein the upstanding posts have a proximal end attached to the backing and a distal end with no overhanging portion.

In a thirty-ninth embodiment, the present disclosure provides the method of any one of the thirty-second to thirty-sixth embodiments, wherein the first layer comprises the upstanding posts protruding from the first surface of the backing, and wherein the upstanding posts have a proximal end attached to the backing and a distal cap larger in area than a cross-sectional area of the proximal end with the distal cap having overhanging portions extending in at least two opposing directions.

In a fortieth embodiment, the present disclosure provides the method of the thirty-ninth embodiment, wherein upstanding posts have mushroom-shaped caps.

In a forty-first embodiment, the present disclosure provides the method of any one of the thirty-second or thirty-third embodiments, wherein the first layer comprises the fibrous loop protruding from the first surface of the backing, and wherein the fibrous loop comprises at least one of the knitted fibrous web or the sheet of fibers having arcuate portions projecting from the first surface of the backing.

In a forty-second embodiment, the present disclosure provides the method of the forty-first embodiment, wherein the first layer comprises the fibrous loop protruding from the first surface of the backing, and wherein the fibrous loop comprises the sheet of fibers having arcuate portions projecting from the first surface of the backing.

In a forty-third embodiment, the present disclosure provides the method of any one of the thirty-second to forty-second embodiments, wherein the backing does not have perforations therethrough.

In a forty-fourth embodiment, the present disclosure provides the method of any one of the thirty-second to forty-second embodiments, wherein the backing has openings therethrough.

In a forty-fifth embodiment, the present disclosure provides the method of any one of the thirty-second to forty-fourth embodiments, wherein the backing has an average thickness of up to 510 micrometers.

In a forty-sixth embodiment, the present disclosure provides the method of any one of the thirty-second to forty-fifth embodiments, wherein the backing comprises at least one of a polyolefin, polyamide, or polyester.

In a forty-seventh embodiment, the present disclosure provides the method of any one of the thirty-second to forty-sixth embodiments, wherein the backing comprises at least one of polypropylene or polyethylene.

In a forty-eighth embodiment, the present disclosure provides the method of any one of the thirty-second to forty-seventh embodiments, wherein the backing has stretch-induced molecular orientation in at least one direction.

In a forty-ninth embodiment, the present disclosure provides the method of any one of the thirty-second to forty-eighth embodiments, further comprising a carrier laminated to a second surface of the backing, opposite the first surface.

In a fiftieth embodiment, the present disclosure provides the method of the forty-ninth embodiment, wherein the carrier comprises at least one of a nonwoven material, a knit material, or a film.

In a fifty-first embodiment, the present disclosure provides the method of the forty-ninth or fiftieth embodiment, further comprising an adhesive on a surface of the carrier opposite the second surface of the backing.

In a fifty-second embodiment, the present disclosure provides the method of any one of the thirty-second to forty-eighth embodiments, further comprising an adhesive on a second surface of the backing, opposite the first surface.

In a fifty-third embodiment, the present disclosure provides the method of the fifty-first or fifty-second embodiment, wherein the adhesive is a pressure sensitive adhesive.

In a fifty-fourth embodiment, the present disclosure provides the method of any one of the thirty-second to fifty-third embodiments, wherein the first layer is adhered to the substrate.

In a fifty-fifth embodiment, the present disclosure provides the method of any one of the thirty-second to fifty-fourth embodiments, wherein the composition further comprises at least one of water or aggregate.

In a fifty-sixth embodiment, the present disclosure provides the method of any one of the thirty-second to fifty-fifth embodiments, wherein the composition comprises lime.

In order that this disclosure can be more fully understood, the following examples are set forth. It should be understood that these examples are for illustrative purposes only and are not to be construed as limiting this disclosure in any manner.

### EXAMPLES

Materials

| | |
|---|---|
| PS Hook | A recloseable fastener hook available under the trade |
| | designation “3M PS-SERIES HOOK CHK-05084” from 3M |
| | Company, St. Paul, MN, having nail shaped heads 300 |
| | micrometers in diameter and with 1600 hooks per square inch |
| | (248 hooks/square centimeter) |
| UNIPRO150 SMS | A white spunbond/meltblown/spunbond filter media |
| | containing 100% polypropylene and having an areal weight of |
| | 51.2 grams/square meter (1.50 ounces/square yard) and an |
| | air permeability of (518 liters/second)/square meter ((102 |
| | cubic feet/minute)/square foot), available under the trade |
| | designation “UNIPRO 151 SMS” From Midwest Filtration, |
| | LLC, Cincinnati, OH. |
| UNIPRO 190 PC Black | A black spunbond polypropylene nonwoven having a basis |
| | weight of 64.4 grams/square meter, available under the trade |
| | designation “UNIPRO 190 PC BLACK” from Midwest |
| | Filtration LLC, Cincinnati, OH. |
| SJ3402 | A plain backed, woven nylon hook having a flexible, self- |
| | supporting inverted J-hooks protruding up from the backing |
| | with approximately 300 hooks per square inch (47 |
| | hooks/square centimeter) available under the trade designation |
| | “3M HOOK AND LOOP FASTENER SJ3402” from 3M |
| | Company, St. Paul, MN. |
| SJ3442 | A black, plain backed, no adhesive reclosable fastening having |
| | 170 mushroom shaped stems per square inch (26 hooks per |
| | square centimeter) with an engaged thickness of 0.16 inches |
| | (0.41 cm), available under the trade designation “3M DUAL |
| | LOCK SJ3442” from 3M Company, St. Paul, MN. |
| SJ3441 | A black, plain backed, no adhesive reclosable fastening system |
| | having 400 mushroom shaped stems per square inch (62 hooks |
| | per square centimeter) with an engaged thickness of 0.16 |
| | inches (0.41 cm), available under the trade designation “3M |
| | DUAL LOCK SJ3441” from 3M Company, St. Paul, MN. |
| DP100 | A fast setting, two-part, 1:1 mix ratio mercaptan-cured epoxy |
| | adhesive available under the trade designation “3M SCOTCH- |
| | WELD EPOXY ADHESIVE DP100 PLUS CLEAR” from 3M |
| | Company, St. Paul, MN. |
| IOA | isooctyl acrylate |
| AA | acrylic acid |
| IRGACURE 651 | 2-dimethoxy-2-phenylacetophenone, a photoinitiator available |
| | under the trade designation “IRGACURE 651” from BASF |
| | Corporation, Florham Park, NJ. |
| FORAL 85LB | A glycerol ester of highly hydrogenated wood rosin, available |
| | under the trade designation “FORAL 85LB” from Pinova |
| | Incorporated, Brunswick GA. |
| Triazine | 2,6-bis-trichoromethyl-6-(3,4-dimethoxyphenyl)-s-triazine |
| FENTRIM 2 | A black colored single sided adhesive tape having a high |
| | performance adhesive on a special film/nonwoven fleece |
| | combination made of polyolefin (PO) and having a perforation |
| | zone, available under the trade designation “FENTRIM 2” |
| | from SIGA, Ruswil, Switzerland. |
| CFT00362 | A nonwoven fastening tape having a polypropylene nonwoven |
| | backing with a polypropylene coating on one side, the |
| | nonwoven backing having a basis weight of 50 grams/square |
| | meter and the areal coverage of the polypropylene coating |
| | being 26.7 grams/square meter, available under the trade |
| | designation “CFT000362” from 3M Company, St. Paul, MN. |
| KERDI | A soft, pliable 0.008 inch (203 micrometers) thick |
| | polyethylene-based waterproofing membrane and vapor- |
| | retarder having an anchoring fleece on both sides, available |
| | under the trade designation “SCHLUTER-KERDI” from |
| | Schluter Systems L.P., Plattsburgh, NY. |
| EBL | An extrusion bonded corrugated nonwoven loop sheet having |
| | polypropylene fibers backed with a polypropylene resin and |
| | having a basis weight of 100 grams/square meter, available |
| | under the trade designation 3M NONWOVEN LANDING |
| | ZONE EBL TU CLP-06222, also referred to as 3M OLF |
| | (White Overlap Fastener) from 3M Company, St. Paul, MN. |

Test Methods

Adhesion Strength: Method A: Unperforated Tape

Tape samples measuring 2 inches by 8 inches (5.1 centimeters by 20.3 centimeters) were adhered to an aluminum panel measuring 2 inches by 5 inches by 0.062 inches (5.1 centimeters by 12.7 centimeters by 1.59 millimeters) by passing a 4.5 pound (2.04 kilogram) rubber roller twice in each direction over the tape such that the pressure sensitive adhesive layer of the tape intimately contacted the aluminum panel. A rectangular shaped polyethylene mold measuring 4.5 inches by 2 inches by 0.75 inches (11.4 centimeters by 5.1 centimeters by 1.9 centimeters) and having three cavities, each measuring 2.54 centimeters by 2.54 centimeters by 1.9 centimeters, was positioned over the aluminum panel on the exposed tape surface and concrete mixture containing 108 grams Portland cement, 216 grams sand, 76 grams of H₂O poured into the cavities to fill them. Next, a metal “S” shaped hook having a top to bottom straight line length of 3.3 centimeters was embedded in the concrete mixture such that about half its length protruded up above the mixture. The concrete mixture was cured at 49° C. for 16 hours after which the mold was removed and the force required to remove the cured concrete block from the tape was measured using a tensile tester equipped with a 22.5 pound (10.2 kilogram) load cell at a rate of 1 inch/minute. The “S” hook was pulled up (perpendicular) from the panel. Three samples were evaluated and the average value was reported in Newtons (N).

Method B: Perforated Tape

Tape samples having perforations through the backing and adhesive layers were evaluated as described in “Adhesion Strength—Method A: Unperforated Tape” above with the following modification. A concrete block measuring 5 inches by 5 inches by 1 inch (12.7 centimeters by 12.7 centimeters by 2.5 centimeters) was used in place of the aluminum panel. Prior to use the block was cleaned using tap water and a nylon brush, then dried in an oven at 158° F. (70° C.) for more than one hour, then allowed to cool to room temperature overnight.

### Example 1

An adhesive transfer tape was prepared as follows. A pressure sensitive adhesive precursor composition was prepared by mixing 99 parts by weight (pbw) IOA, 1 pbw AA, and 0.04 pbw of “IRGACURE 651”. This mixture was partially polymerized under a nitrogen atmosphere by exposure to low intensity ultraviolet radiation to provide a coatable syrup having a viscosity of about 4000 centipoise. The UVA light source had a UVA peak emission wavelength in the range of 360 to 400 nanometers. An additional 0.26 pbw of “IRGACURE 651”, 0.13 pbw of Triazine, and 6 pbw of FORAL 85LB were added to the syrup and mixed until all of the components had completely dissolved to give a pressure sensitive adhesive precursor composition.

The adhesive precursor composition was then coated onto the siliconized polyethylene coated side of a Kraft paper release liner using a notch bar coater having a gap setting of 0.076 millimeters (0.003 inches) greater than the thickness of the release liner. The coated liner was then exposed to an ultraviolet radiation source having a spectral output from 300-400 nanometers with a maximum at 351 nanometers in a nitrogen-rich environment. An irradiance of about 9.0 milliWatts/square centimeter was used to provide a total energy of 1800 milliJoules/square centimeter. An adhesive transfer tape having a cured pressure sensitive adhesive on one side of a release liner was obtained.

Separately, PS Hook was hot air bonded to “UNIPRO 150 SMS” using the procedure described in the Example of U.S. Pat. No. 8,956,496 (Biegler et al.).

The adhesive transfer tape was laminated to the side of the “UNIPRO 150 SMS” opposite that bonded to the PS Hook using a 4.5 pound (2.04 kilogram) rubber roller to ensure intimate contact. A tape construction having PS Hook on one side of a “UNIPRO 150 SMS” substrate and a pressure sensitive adhesive on the other side was obtained. This tape was then evaluated as described in “Adhesion Strength—Method A: Unperforated Tape” above.

### Example 2

Example 1 was repeated with the following modification. “UNIPRO 190 PC BLACK” was used in place of “UNIPRO 150 SMS”.

### Example 3

Example 1 was repeated with the following modification. SJ3402 was used in place of the PS Hook and it was bonded to the “UNIPRO 150 SMS” substrate using DP100 as follows. Uncured DP100 adhesive was evenly applied to one side of the UNIPRO 150 SMS using a wooden tongue depressor. Next, SJ3402 was positioned on the coating of uncured DP100. After 20 minutes at room temperature the mold was positioned and concrete poured into the cavities. This assembly was then placed in an oven at 120° F. (49° C.) for 16 hours.

### Example 4

Example 3 was repeated with the following modification. SJ3442 was used in place of SJ3402.

### Example 5

Example 3 was repeated with the following modification. A SJ3442 precursor which did not have mushroom shaped heads was used in place of SJ3402.

### Example 6

Example 3 was repeated with the following modification. SJ3441 was used in place of SJ3402.

### Example 7

Example 1 was repeated with the following modification. No “UNIPRO 150 SMS” was employed and SJ3402 was used in place of the PS Hook, The SJ3402 layer was bonded directly to the aluminum substrate using the pressure sensitive adhesive transfer tape.

### Example 8

Example 7 was repeated with the following modification. SJ3442 was used in place of SJ3402.

### Example 9

Example 1 was repeated with the following modification, EBL was used in place of PS HOOK and “UNIPRO 150 SMS”. A tape construction having a polypropylene core with an extrusion bonded loop on one side and a pressure sensitive adhesive on the other side was obtained.

### Comparative Example 1

The unperforated area of “FENTRIM 2” tape was evaluated as described in “Adhesion Strength—Method A: Unperforated Tape” above.

### Comparative Example 2

The perforated area of “FENTRIM 2” tape was evaluated as described in “Adhesion Strength—Method B: Perforated Tape” above.

### Comparative Example 3

Example 1 was repeated with the following modification. PS Hook was not used.

### Comparative Example 4

Example 2 was repeated with the following modification. PS Hook was not used.

### Comparative Example 5

Example 1 was repeated with the following modification. “CFT00362” was used in place of PS HOOK and “UNIPRO 150 SMS”. A tape construction having in order: a pressure sensitive adhesive layer, a polypropylene layer, and a nonwoven polypropylene layer.

### Comparative Example 6

Comparative Example 5 was repeated with the following modification. “KERDI” membrane was used place of CFT00362. A tape construction having a polyethylene core with an anchoring fleece layer on both sides and a pressure sensitive adhesive covering one of the fleece sides was obtained.

Adhesion Strength

| | | Adhesion | |
|---|---|---|---|
| Example | Test Method | Strength (N) | Failure Mode |
| 1 | A | 57.5 | At the interface between |
| | | | the concrete and hook |
| | | | layers |
| 2 | A | 50.9 | At the interface between |
| | | | the concrete and hook |
| | | | layers |
| 3 | A | 221.1 | At the interface between |
| | | | the concrete and hook |
| | | | layers |
| 4 | A | 140.4 | At the interface between |
| | | | the concrete and hook |
| | | | layers |
| 5 | A | 161.8 | At the interface between |
| | | | the concrete and hook |
| | | | layers |
| 6 | A | 33.0 | At the interface between |
| | | | the concrete and hook |
| | | | layers |
| 7 | A | 131.9 | At the interface between |
| | | | adhesive and hook |
| | | | layers |
| 8 | A | 131.0 | At the interface between |
| | | | adhesive and hook |
| | | | layers |
| 9 | A | 77.1 | Fiber extension from |
| | | | backing |
| CE 1 | A | 56.3 | At the interface between |
| | | | the concrete and |
| | | | FENTRIM 2 layers |
| CE 2 | B | 24.8 | In the perforated areas |
| | | | and at the interface |
| | | | between the concrete |
| | | | and FENTRIM layers |
| CE 3 | A | 53.0 | At the interface between |
| | | | the concrete and |
| | | | UNIPRO 150 layers |
| CE 4 | A | 30.3 | At the interface between |
| | | | the concrete and |
| | | | UNIPRO 190 layers |
| CE 5 | A | 53.6 | Fiber extension from |
| | | | backing |
| CE 6 | A | 42.3 | Fiber extension from |
| | | | backing |

This disclosure may take on various modifications and alterations without departing from its spirit and scope. Accordingly, this disclosure is not limited to the above-described embodiments but is to be controlled by the limitations set forth in the following claims and any equivalents thereof. This disclosure may be suitably practiced in the absence of any element not specifically disclosed herein.

1. An article comprising:
a first layer comprising a backing and upstanding posts or a fibrous loop protruding from a first surface of the backing, wherein the fibrous loop comprises at least one of a sheet of fibers having arcuate portions projecting from the first surface of the backing, a knitted fibrous web, or a needle-punched nonwoven web, and wherein the upstanding posts have a proximal end attached to the backing and a distal end larger in area than a cross-sectional area of the proximal end with the distal end having overhanging portions extending in at least two opposing directions, or wherein the upstanding posts have a proximal end attached to the backing and a distal end with no overhanging portion;
a composite layer comprising at least one of gypsum, lime, or cement, wherein the composite layer is at least one of dried or cured on the first surface of the backing, wherein at least a portion of the upstanding posts or the fibrous loop is embedded in the composite layer, and
an adhesive, wherein the adhesive is on a second surface of the backing, opposite the first surface, or on a carrier laminated to a second surface of the backing, opposite the first surface.

2. An article comprising:
a first layer comprising a backing and upstanding posts at a density of up to 248 per square centimeter or a fibrous loop protruding from a first surface of the backing, wherein the fibrous loop comprises at least one of a sheet of fibers having arcuate portions projecting from the first surface of the backing, a knitted fibrous web, or a needle-punched nonwoven web;
a composite layer comprising at least one of gypsum, lime, or cement, wherein the composite layer is at least one of dried or cured on the first surface of the backing, wherein at least a portion of the upstanding posts or the fibrous loop is embedded in the composite layer, and
an adhesive, wherein the adhesive is on a second surface of the backing, opposite the first surface, or on a carrier laminated to a second surface of the backing, opposite the first surface.

3. The article of claim 1, wherein first surface of the backing has a density of upstanding posts of up to 124 per square centimeter.

4. The article of claim 1, wherein the first layer comprises the upstanding posts protruding from the first surface of the backing, and wherein the upstanding posts have a proximal end attached to the backing and a distal end with no overhanging portion.

5. The article of claim 1, wherein the first layer comprises the fibrous loop protruding from the first surface of the backing, and wherein fibrous loop comprises the sheet of fibers having arcuate portions projecting from the first surface of the backing.

6. The article of claim 1, wherein the backing does not have perforations therethrough.

7. The article of claim 1, wherein the backing comprises at least one of a polyolefin, nylon, or polyester.

8. The article of claim 1, further comprising the carrier laminated to the second surface of the backing, opposite the first surface, wherein the carrier comprises at least one of a nonwoven material, a knit material, or a film.

9. The article of claim 1, wherein the adhesive is a pressure sensitive adhesive.

10. (canceled)

11. A method of making the article of claim 1, the method comprising:
providing the first layer on a substrate, with the second surface of the backing, opposite the first surface, facing the substrate, wherein the first layer is adhered to the substrate;
applying a composition comprising at least one of gypsum, lime, or cement to the first surface of the backing; and
at least one of curing or drying the composition to form the composite layer on the first surface of the backing.

12. The method of claim 11, wherein the article is at least a portion of an interior wall, an exterior wall, a floor, a ceiling, or a roof.

13. The method of claim 11, wherein the substrate comprises at least one of wood, vinyl, metal, or concrete.

14. A method of installing at least one of a door or window, the method comprising:
attaching a first layer comprising a backing and upstanding posts or a fibrous loop protruding from a first surface of the backing to at least a portion of a door or window frame, wherein the fibrous loop comprises at least one of a sheet of fibers having arcuate portions projecting from the first surface of the backing, a knitted fibrous web, or a needle-punched nonwoven web;
applying a composition comprising at least one of gypsum, lime, or cement to the first surface of the backing; and
at least one of curing or drying the composition to form a composite layer on the first surface of the backing.

15. The method of claim 14, wherein the composition further comprises at least one of water or aggregate.

16. The article of claim 2, wherein first surface of the backing has a density of upstanding posts of up to 124 per square centimeter.

17. The article of claim 2, wherein the first layer comprises the upstanding posts protruding from the first surface of the backing, and wherein the upstanding posts have a proximal end attached to the backing and a distal end with no overhanging portion.

18. The article of claim 2, wherein the first layer comprises the fibrous loop protruding from the first surface of the backing, and wherein fibrous loop comprises the sheet of fibers having arcuate portions projecting from the first surface of the backing.

19. The article of claim 2, wherein the backing does not have perforations therethrough.

20. The article of claim 2, wherein the backing comprises at least one of a polyolefin, nylon, or polyester.

21. The article of claim 2, further comprising the carrier laminated to the second surface of the backing, opposite the first surface, wherein the carrier comprises at least one of a nonwoven material, a knit material, or a film.
